(19) United States
(12) Patent Application Publication
(10) Pub. No.: US 2024/0219596 A1
(43) Pub. Date: Jul. 4, 2024

(54) METHOD AND APPARATUS FOR ESTIMATING UNCERTAINTY OF A VELOCITY MODEL OF A SUBSURFACE REGION

(71) Applicant: BP Corporation North America Inc., Houston, TX (US)

(72) Inventors: Tongning Yang, Houston, TX (US); Linda Hodgson, Aberdeen (GB); Eric Kazlauskas, Houston, TX (US)

(73) Assignee: BP Corporation North America Inc., Houston, TX (US)

(21) Appl. No.: 18/394,283

(22) Filed: Dec. 22, 2023

Related U.S. Application Data
(60) Provisional application No. 63/436,803, filed on Jan. 3, 2023.

(51) Int. Cl. G01V 1/28; G01V 1/30

(52) U.S. Cl. CPC G01V 1/282; G01V 1/303

(57) ABSTRACT

A method for estimating uncertainty of an output of a velocity model of a subsurface region includes receiving seismic data associated with a subsurface region and captured by one or more seismic receivers, constructing a velocity model of the subsurface region based on the received seismic data, performing a seismic migration of the received seismic data based on the constructed velocity model to obtain migrated seismic data, generating a semblance panel from the migrated seismic data, and estimating an uncertainty of the output of the velocity model based on the generated semblance panel.

### CROSS-REFERENCE TO RELATED APPLICATIONS

The present application claims benefit of U.S. provisional patent application No. 63/436,803 filed Jan. 3, 2023, entitled “Method and Apparatus for Estimating Uncertainty of a Velocity Model of a Subsurface Region”, which is hereby incorporated herein in its entirety for all purposes.

### STATEMENT REGARDING FEDERALLY SPONSORED RESEARCH OR DEVELOPMENT

Not applicable.

### BACKGROUND

Seismic surveying is a method of exploration geophysics in which seismology is used to estimate properties of earthen subsurface regions from reflected seismic waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off the interface and is recorded at the surface as seismic data associated with the subsurface region, while some of the wave energy refracts through the interface and penetrates deeper into the subsurface region. The reflected wave energy recorded at the surface as seismic data may be studied to ascertain information about the subsurface region. For example, the recorded seismic data may be used to construct a velocity model of the subsurface region. In general, a velocity model models the velocity of the seismic waves passing through the subsurface region so as to translate subsurface reflection points of the seismic waves to their true depth within the formation.

### SUMMARY

An embodiment of a method for estimating uncertainty of an output of a velocity model of a subsurface region comprises (a) receiving seismic data associated with a subsurface region and captured by one or more seismic receivers, (b) constructing a velocity model of the subsurface region based on the received seismic data, (c) performing a seismic migration of the received seismic data based on the constructed velocity model to obtain migrated seismic data, (d) generating a semblance panel from the migrated seismic data, and (e) estimating an uncertainty of the output of the velocity model based on the generated semblance panel. In some embodiments, (c) comprises generating one or more seismic gathers using the constructed velocity model. In some embodiments, the semblance panel is generated from the one or more seismic gathers. In certain embodiments, (e) comprises estimating the uncertainty of a seismic velocity estimated from the velocity model, wherein the uncertainty comprises a lower bound and a separate upper bound. In certain embodiments, a first uncertainty window extends between the lower bound and the estimated seismic velocity and a second uncertainty window extends between the estimated seismic velocity and the upper bound. In some embodiments, the width of the first uncertainty window and the width of the second uncertainty window vary across different depths of the subsurface region. In some embodiments, (e) comprises taking the derivative of the output of the velocity model to estimate the uncertainty of the output.

An embodiment of a method estimating uncertainty of an estimated seismic velocity produced by a velocity model of a subsurface region comprises (a) receiving seismic data associated with a subsurface region and captured by one or more seismic receivers, (b) constructing a velocity model of the subsurface region based on the received seismic data, (c) performing a seismic migration of the received seismic data based on the constructed velocity model to obtain migrated seismic data, and (d) determining, using the velocity model and the migrated seismic data, an estimated seismic velocity of the subsurface region at a given depth, a minimum velocity bound at the given depth that is less than the estimated seismic velocity, and a maximum velocity bound at the given depth that is greater than the estimated seismic velocity. In some embodiments, the estimated seismic velocity comprises a point along a seismic velocity curve, and wherein (d) comprises taking the derivative of the migrated seismic data to identify the minimum velocity bound and the maximum velocity bound. In some embodiments, the minimum velocity bound is associated with a first peak along the derivative of the migrated seismic data, and the maximum velocity bound is associated with a second peak along the derivative of the migrated seismic data that is adjacent to the first peak. In certain embodiments, the estimated seismic velocity is associated with a trough along the derivative of the migrated seismic data that is positioned between the first peak and the second peak. In certain embodiments, a first uncertainty window extends between the minimum velocity bound and the estimated seismic velocity, and a second uncertainty window extends between the estimated seismic velocity and the maximum velocity bound. In some embodiments, the width of the first uncertainty window and the width of the second uncertainty window vary across different depths of the subsurface region. In some embodiments, (c) comprises generating one or more seismic gathers using the constructed velocity model. In certain embodiments, the method comprises (e) generating a semblance panel from the migrated seismic data, wherein the semblance panel is generated from the one or more seismic gathers.

An embodiment of a system for estimating uncertainty of an output of a velocity model of a subsurface region comprises a processor, a non-transitory memory, and an application stored in the non-transitory memory that, when executed by the processor receives seismic data associated with a subsurface region and captured by one or more seismic receivers, constructs a velocity model of the subsurface region based on the received seismic data, performs a seismic migration of the received seismic data based on the constructed velocity model to obtain migrated seismic data, generates a semblance panel from the migrated seismic data, and estimates an uncertainty of the output of the velocity model based on the generated semblance panel. In some embodiments, the output comprises an estimated seismic velocity estimated from the velocity model, and wherein the uncertainty comprises a lower bound and a separate upper bound. In some embodiments, a first uncertainty window extends between the lower bound and the estimated seismic velocity and a second uncertainty window extends between the estimated seismic velocity and the upper bound. In certain embodiments, the width of the first uncertainty window and the width of the second uncertainty window vary across different depths of the subsurface region. In certain embodiments, the application, when executed by the processor takes the derivative of the output of the velocity model to estimate the uncertainty of the output.

### BRIEF DESCRIPTION OF THE DRAWINGS

For a detailed description of various exemplary embodiments, reference will now be made to the accompanying drawings in which:

FIG. 1 is a schematic view of an embodiment of a system for performing a marine seismic survey in accordance with principles described herein;

FIG. 2 is a schematic view of an embodiment of a system for performing a land-based seismic survey in accordance with principles described herein;

FIG. 3 is a block diagram of an embodiment of a computer system in accordance with principles described herein;

FIG. 4 is a flowchart illustrating an embodiment of a method for estimating uncertainty of an output of a velocity model of a subsurface region in accordance with principles described herein;

FIG. 5 is an exemplary image of a prestack, depth-migrated seismic gather;

FIG. 6 is an exemplary image of a semblance panel;

FIG. 7 is an exemplary graph of an estimated seismic velocity curve and a derivative curve;

FIG. 8 is an exemplary image of a bounded semblance panel;

FIG. 9 is an exemplary velocity scalar panel;

FIG. 10 is an exemplary graph of an estimated seismic velocity; and

FIG. 11 is a zoomed-in view of the graph of FIG. 10.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, seismic surveys reflect seismic waves off of features of earthen subsurface regions in order to collect information regarding the subsurface regions. The information collected from the reflected seismic waves may be used to create velocity models and seismic images, which may be used to identify subterranean features of interest such as, for example, hydrocarbon deposits. As an example, in some applications an iterative data-fitting process such as a full waveform inversion (FWI) process may be applied to the collected seismic data to form a velocity model therefrom. Typically, FWI processes for generating velocity models of subsurface regions include comparing synthetic seismic information generated by an initial estimate of the velocity model with the collected seismic data to iteratively minimize an objective cost function.

The computed velocity model may be used to image structures located within a subsurface region using a variety of techniques including, for example, prestack depth migration (PSDM) techniques. The quality of seismic images of a subsurface region produced from a velocity model is contingent on the accuracy of the velocity model from which the seismic images are produced. A continuing problem in the field of seismic imaging of subsurface regions is the determination of uncertainty of the velocity model from which seismic images and other seismic products are produced. Conventional methods for determining the uncertainty of a given velocity model are limited. Generally, the uncertainty of a velocity model is typically determined by comparing an output of a velocity model of a given subsurface region with data obtained from a well penetrating the subsurface region as part of a well-tie-based uncertainty analysis. However, well data can only be applied at a limited number of discretely separate depths where there is clear correspondence with the obtained seismic data such that a comparison can be drawn between the well and seismic data, thereby limiting the potential of well data in determining uncertainty of the velocity model. Due to these limitations, a seismic velocity estimated from a velocity model at a given depth in a subsurface region amounts to a best guess of the seismic velocity at the given depth that does not include the uncertainty of the estimate.

Accordingly, embodiments of methods and apparatuses for estimating uncertainty of an output of a velocity model of a subsurface region are provided herein. In some embodiments, the output of the velocity model comprises an estimated seismic velocity of the subsurface region at one or more depths thereof as estimated by the velocity model. Specifically, the uncertainty may comprise a lower bound corresponding to a minimum velocity bound that is equal to or less than the estimated seismic velocity at the given depth, and an upper bound corresponding to a maximum velocity bound that is equal to or greater than the estimated seismic velocity at the given depth. In some embodiments, the uncertainty of the velocity model output is estimated by taking the derivative of the output, wherein the estimated output comprises a point located along an output curve. Particularly, in certain embodiments, a derivative curve is obtained from the output curve and a pair of peaks of the derivative curve flanking the estimated output (corresponding to a trough on the derivative curve between the pair of peaks). A first peak on the derivative curve on a “low side” of the estimated output may be taken as the lower bound for the estimated uncertainty of the output, while a second peak on the derivative curve on the “high side” of the estimated output may be taken as the upper bound for the estimated uncertainty of the output. In this manner, an uncertainty for the estimated output of the velocity model may be quickly and conveniently determined without needing to confer between the estimated outputs of a large number of different velocity models for the same subsurface region.

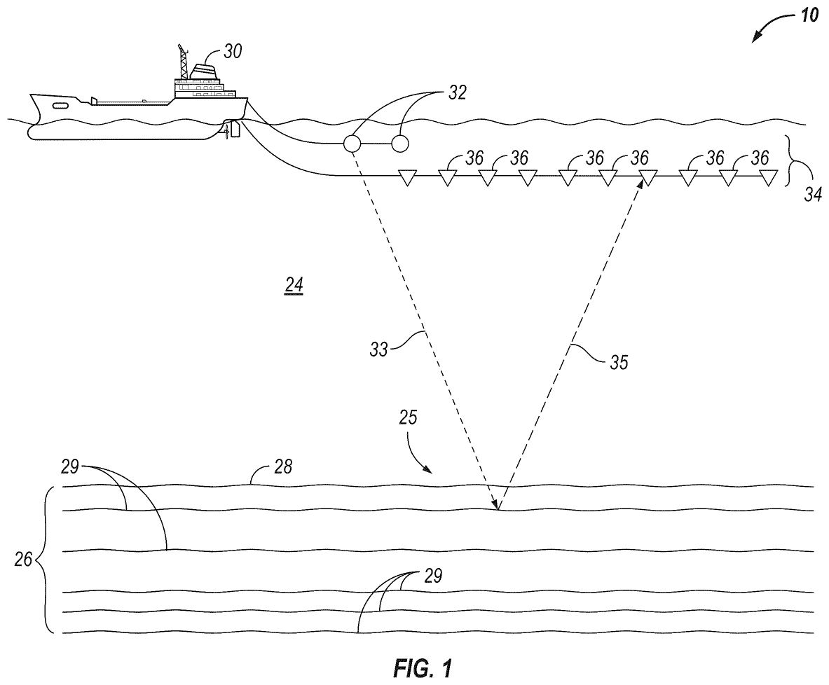

Referring initially to FIG. 1, an embodiment of a marine survey system 10 that may be employed to acquire seismic data (e.g., waveforms) regarding a subsurface region of the Earth in a marine environment is shown. Generally, a marine seismic survey conducted using the marine survey system 10 shown in FIG. 1 may be conducted in an ocean 24 or other body of water over a subsurface region 26 of the Earth that lies beneath a seafloor 28. In this exemplary embodiment, marine survey system 10 generally includes a marine vessel 30 at the surface of the ocean 24, one or more seismic sources 32, a seismic streamer 34, one or more seismic receivers 36, and/or other equipment that may assist in acquiring seismic images representative of geological formations within the subsurface region 26 of the Earth.

The marine vessel 30 tows the seismic sources 32 (e.g., an array of air guns) over an area of interest (AOI) 25 of the subsurface region as the seismic sources 32 repeatedly produce sound waves (e.g., emitted seismic waves indicated by arrow 33 in FIG. 1) that are directed at the seafloor 28 and towards the AOI 25. As the emitted seismic waves 33 penetrate through the subsurface region 26, some of the seismic energy of the seismic waves 33 is reflected off of one or more subsurface reflectors 29 formed within the subsurface region 26 such that the reflected seismic energy (e.g., reflected seismic waves indicated by arrow 35 in FIG. 1) travels back towards the surface of the ocean 24. In general, subsurface reflectors 29 of subsurface region 26 may comprise a variety of diverse geological features and formations including, for example, salt domes, faults, folds, interfaces between different subsurface materials, and other features.

As the marine vessel 30 tows the seismic sources 32 over the AOI 25, the marine vessel 30 may concurrently tow the seismic receivers 36 (e.g., hydrophones), which detect and capture the reflected seismic waves 35 that represent the energy output by the seismic sources 32 subsequent to being reflected off of the reflectors 29 within the subsurface region 26. The reflected seismic waves 35 captured by seismic receivers 36 comprises seismic data that may be processed by a computer system to generate one or more images and/or velocity models associated with the subsurface region 26. For example, images constructed from the captured seismic data may visually depict various features of the subsurface region 26 including at least some of reflectors 29 of the subsurface region 26. Additionally, velocity models constructed from the captured seismic data may be used to estimate the vertical depth (from the seafloor 28) of various features of the subsurface region 26 including the vertical depth of at least some of the reflectors 29 thereof.

The images, velocity models, and other information gleaned from the captured seismic data may be utilized in locating hydrocarbon deposits within subsurface region 26. For example, the captured seismic data may be analyzed to generate a map or profile that illustrates various geological formations within the subsurface region 26. Based on the identified locations and properties of the hydrocarbon deposits determined from the captured seismic data, certain positions or parts (e.g., AOI 25) of the subsurface region 26 may be explored. That is, hydrocarbon exploration organizations may use the locations of the hydrocarbon deposits to determine locations at the surface (seafloor 28 in this exemplary embodiment) of the subsurface region 26 to drill into the Earth. As such, the hydrocarbon exploration organizations may use the locations and properties of the hydrocarbon deposits and the associated overburdens to determine a path along which to drill into the Earth, how to drill into the Earth, and the like. After exploration equipment has been placed within the subsurface region, the hydrocarbons that are stored in the identified hydrocarbon deposits may be produced via natural flowing wells, artificial lift wells, and the like.

It may be understood that the number of seismic sources 32 and the number of seismic receivers 36 of the marine survey system 10 may vary depending on the given application. In the same manner, although marine survey system 10 is described with one seismic streamer 34, it should be noted that the marine survey system 10 may include multiple streamers similar to streamer 34. Additionally, while seismic sources 32 are described as air guns and seismic receivers 36 are described as hydrophones in this exemplary embodiment, the configuration of sources 32 and receivers 36 may vary in other embodiments. Further, additional marine vessels 30 may include additional seismic sources 32, seismic streamers 34, and the like to perform the operations of the marine survey system 10.

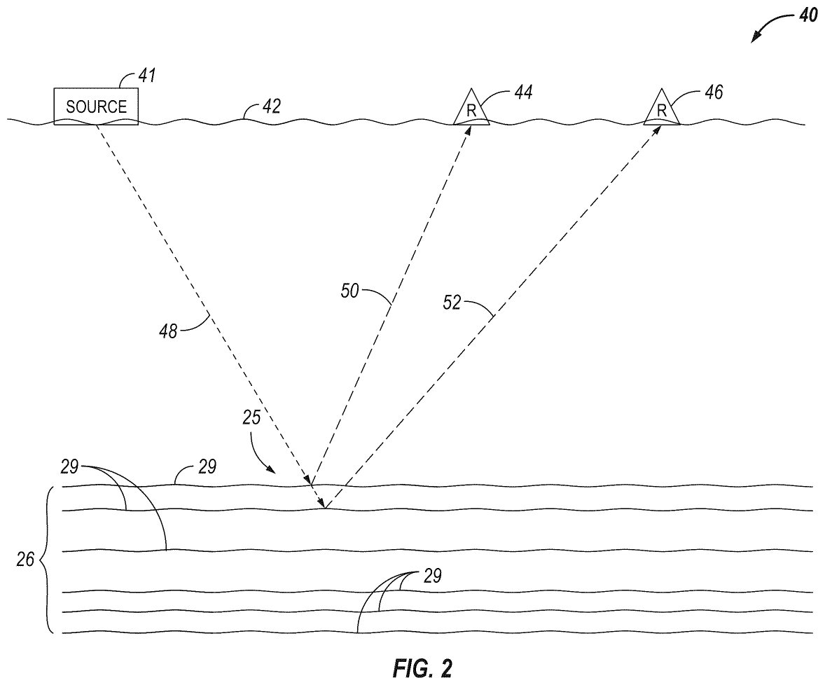

Referring now to FIG. 2, an embodiment of a land survey system 40 that may be employed to obtain information, including captured seismic data, regarding the subsurface region 26 of the Earth in a non-marine environment. In this exemplary embodiment, land survey system 40 generally includes a land-based seismic source 41 and a land-based receiver 44. In some embodiments, the land survey system 40 may include multiple land-based seismic sources 40 and one or more land-based receivers 44, 46. Indeed, for discussion purposes, the land survey system 40 includes a land-based seismic source 41 and two land-based receivers 44, 46.

The land-based seismic source 41 (e.g., a seismic vibrator) of land survey system 40 may be disposed on a surface 42 of the Earth above the subsurface region 26 of interest. The land-based seismic source 41 may produce energy (e.g., emitted seismic waves indicated by arrow 48 in FIG. 2) that is directed at the subsurface region 26 of the Earth. Upon reaching various subsurface reflectors 29 (e.g., salt domes, faults, folds, interfaces, etc.) within the subsurface region 26, the energy output by the land-based seismic source 41 may be reflected (e.g., reflected seismic waves indicated by arrows 50, 52 in FIG. 2) off of the subsurface reflectors 29, and captured by one or more land-based seismic receivers (e.g., seismic receivers 44 and 46).

In some embodiments, the land-based seismic receivers 44, 46 may be dispersed across the surface 42 of the Earth to form a grid-like pattern. As such, each land-based seismic receiver 44, 46 may receive a reflected seismic wave 50, 52 in response to energy being directed at the subsurface region 26 via the seismic source 41. In some cases, one seismic waveform produced by the seismic source 41 may be reflected off of different subsurface reflectors 29 and received by different seismic receivers 44, 46. For example, as shown in FIG. 2, a first seismic receiver 44 may receive the reflection of the emitted seismic waveform 48 off of a first reflector 29 while a second seismic receiver 46 may receive the reflection of the seismic waveform 48 off of a second reflector 29. As such, the first seismic receiver 44 may receive a reflected seismic wave 50 and the second seismic receiver 46 may receive a reflected seismic wave 52.

Regardless of how the seismic data is acquired, a computer system may analyze the seismic waveforms acquired by the seismic receivers (e.g., seismic receivers 36, 44, 46 of survey systems 10, 40 described above) to determine seismic information regarding the geological structure, the location and property of hydrocarbon deposits, and the like within the subsurface region 26.

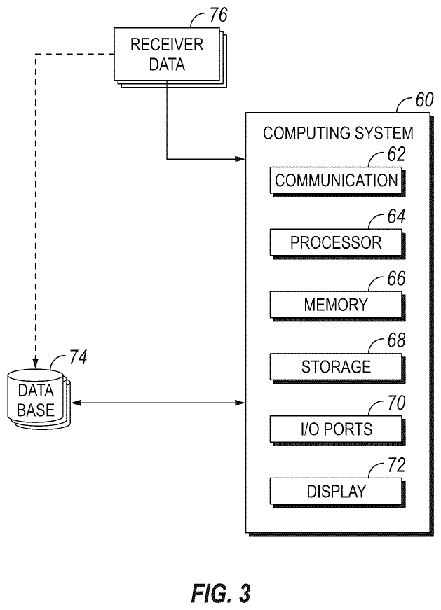

Referring now to FIG. 3, a block diagram of an embodiment of such a computer system 60 that may perform various data analysis operations to analyze the seismic data acquired by the receivers 36, 44, 46 to determine the structure and/or predict seismic properties of the geological formations within the subsurface region 26 is shown. In this exemplary embodiment, computer system 60 generally includes a communication component 62, a processor 64, memory 66, storage 68, input/output (I/O) ports 70, and a display 72. In some embodiments, the computer system 60 may omit one or more of the display 72, the communication component 62, the (I/O) ports 70, or combinations thereof. The communication component 62 may be a wireless or wired communication component that may facilitate communication between the seismic receivers (e.g., seismic receivers 36, 44, and 46), one or more databases 74, other computing devices, and/or other communication capable devices. In one embodiment, the computer system 60 receives receiver data 76 (e.g., captured seismic data, seismograms, etc.) via a network component, databases 74, or the like. The processor 64 of the computer system 60 executes instructions stored on the memory 66 to analyze or process the receiver data 76 to ascertain various features regarding geological formations within the subsurface region 26. As will be discussed further herein, processor 64 particularly executes instructions stored on memory 66 to construct one or more images and/or one or more velocity models of the subsurface region 26.

In general, the processor 64 may be any type of computer processor or microprocessor capable of executing computer-executable code. The processor 64 may also include multiple processors that may perform the operations described below. In general, the memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 executes software applications that include programs that process seismic data acquired via receivers of a seismic survey according to the embodiments described herein.

The memory 66 and the storage 68 are also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 are interfaces that couple to other peripheral components such as input devices (e.g., keyboard, mouse), sensors, input/output (I/O) modules, and the like. I/O ports 70 enable the computer system 60 to communicate with the other devices in the marine survey system 10, the land survey system 40, or the like via the I/O ports 70.

The display 72 depicts visualizations associated with software or executable code being processed by the processor 64. In one embodiment, the display 72 is a touch display capable of receiving inputs from a user of the computer system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. In general, the display 72 may be any suitable type of display, such as a liquid crystal display (LCD), plasma display, or an organic light emitting diode (OLED) display, for example. In addition to depicting the visualization described herein via the display 72, it should be noted that the computer system 60 may also depict the visualization via other tangible elements, such as paper (e.g., via printing) and the like.

With the foregoing in mind, the present techniques described herein may also be performed using a supercomputer that employs multiple computer systems 60, a cloud-based computer system, or the like to distribute processes to be performed across multiple computer systems 60. In this case, each computer system 60 operating as part of a supercomputer may not include each component listed as part of the computer system 60. For example, each computer system 60 may not include the display 72 since multiple displays 72 may not be useful to for a supercomputer designed to continuously process seismic data.

After performing various types of seismic data processing, the computer system 60 may store the results of the analysis in one or more databases 74. The databases 74 may be communicatively coupled to a network (e.g., a wide area network like the Internet) that may transmit and receive data to and from the computer system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computer system 60, it should be noted that similar components may make up the computer system 60. Moreover, the computer system 60 may also be part of the marine survey system 10 and/or the land survey system 40, and thus may monitor and control certain operations of the seismic sources 32 or 41, the seismic receivers 36, 44, 46, and the like. Further, it should be noted that the listed components are provided as example components and the embodiments described herein are not to be limited to the components described with reference to FIG. 3.

In some embodiments, the computer system 60 generates a two-dimensional representation or a three-dimensional representation of the subsurface region 26 based on the seismic data received via the receivers mentioned above. Additionally, seismic data associated with multiple seismic source/receiver combinations may be combined to create a near continuous profile of the subsurface region 26 that can extend for some distance. In a two-dimensional (2D) seismic survey, the receiver locations may be placed along a single line, whereas in a three-dimensional (3D) survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26. In either case, a seismic survey may be composed of a very large number of individual seismic recordings or traces. As such, the computer system 60 may be employed to analyze the acquired seismic data to obtain an image representative of the subsurface region 26 and, using the obtained image, determine locations and properties of desired hydrocarbon deposits within the subsurface region 26 which may be later extracted. To that end, a variety of seismic data processing algorithms may be used to remove noise from the acquired seismic data, migrate the pre-processed seismic data, identify shifts between multiple seismic images, align multiple seismic images, and the like.

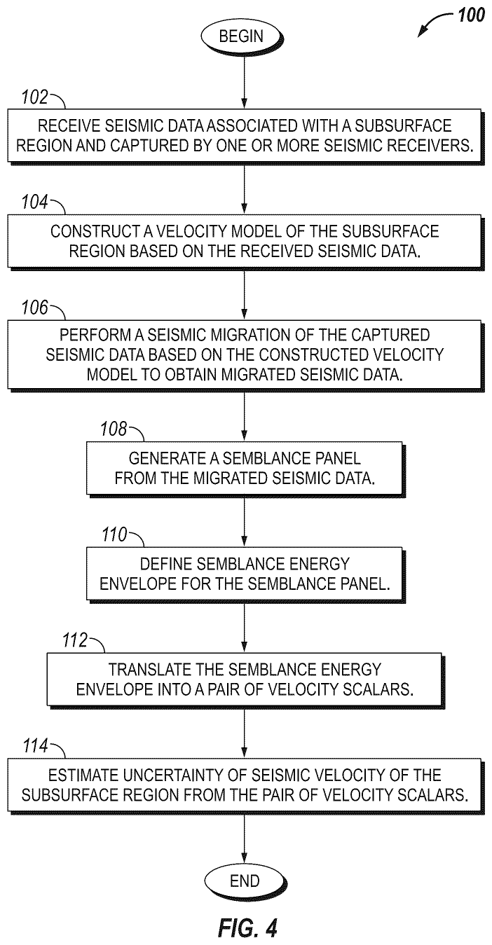

Referring now to FIG. 4, an embodiment of a method 100 for estimating uncertainty of an output of a velocity model of a subsurface region is shown. At least some, if not all, of the steps or “blocks” of method 100 shown in FIG. 4 may be executed by the computer system 60 shown in FIG. 3, although it is to be understood that at least some of the steps of method 100 may be executed by systems other than computer system 60. Additionally, it is to be understood that the uncertainty of the output of the velocity model estimated from method 100 may be used for a variety of purposes, including bulk rock volume (BRV) estimation, volumetric analysis, and in the planning of one or more wells which would extend through the subsurface region.

Beginning at block 102, method 100 includes receiving seismic data associated with a subsurface region (e.g., subsurface region 26) and captured by one or more seismic receivers (e.g., seismic receivers 36, 44, 46). The seismic data received at block 102 comprises reflected seismic data that, after being emitted from a seismic source (e.g., seismic sources 32 and 41), is reflected off of subsurface reflectors (e.g., subsurface reflectors 29) formed in the subsurface region and subsequently captured by the one or more seismic receivers.

At block 104, method 100 includes constructing a velocity model of the subsurface region based on the received seismic data. The velocity mode models the interval velocity of the subsurface region thereby translating the time-domain seismic data into depth-domain data. In some embodiments, block 104 comprises applying a full waveform inversion (FWI) process to construct the velocity model of the subsurface region. Particularly, the FWI process applied at block 104 may comprise an iterative data-fitting process in which an initial velocity model of the subsurface region is constructed and from which synthetic, modeled seismic data may be generated. In other embodiments, processes other than FWI may be used to construct the velocity model at block 104. For example, tomography, velocity scanning techniques, manual editing, scenario testing other processes beyond FWI, or combinations thereof may be utilized for constructing the velocity model at block 104.

As part of the FWI process, the modeled seismic data created from the initial velocity model may be compared to the received seismic data using an objective function that describes the degree of concordance between the modeled seismic data and the received seismic data. Parameters of the initial velocity model may then be updated based on the comparison between the modeled seismic data and the received seismic data in an effort to reduce or minimize the objective function, thereby forming a revised velocity model. Modeled seismic data may again be generated this time from the revised velocity model and compared with the received seismic data to further minimize the objective function. This process may be repeated iteratively until a global minimum of the objective function has been obtained corresponding to a final velocity model of the subsurface region.

Referring again to FIG. 4, at block 106, method 100 comprises performing a seismic migration of the captured seismic data based on the constructed velocity model to obtain migrated seismic data. In some embodiments, the seismic data upon which the seismic migration is performed at block 106 may comprise prestack seismic data, such as prestack reflection gathers. Thus, in at least some embodiments, block 106 comprises performing a prestack seismic migration of the captured seismic data. In certain embodiments, block 106 comprises applying a wave-equation migration process to obtain the migrated seismic data such as RTM process, a one-way wave-equation migration (WEM) process, a Kirchhoff depth migration process, the like, or combinations thereof. The RTM depth migration process may generally include propagating seismic source and seismic receiver wavefields to potential subsurface reflectors in the subsurface region using the wave equation, and generating an image or gather (e.g., a RTM migration seismic image) using the velocity model constructed at block 104. Alternatively, a velocity model of the subsurface region other than the velocity model constructed at block 104 may be utilized in the RTM process to form the RTM migration stack image.

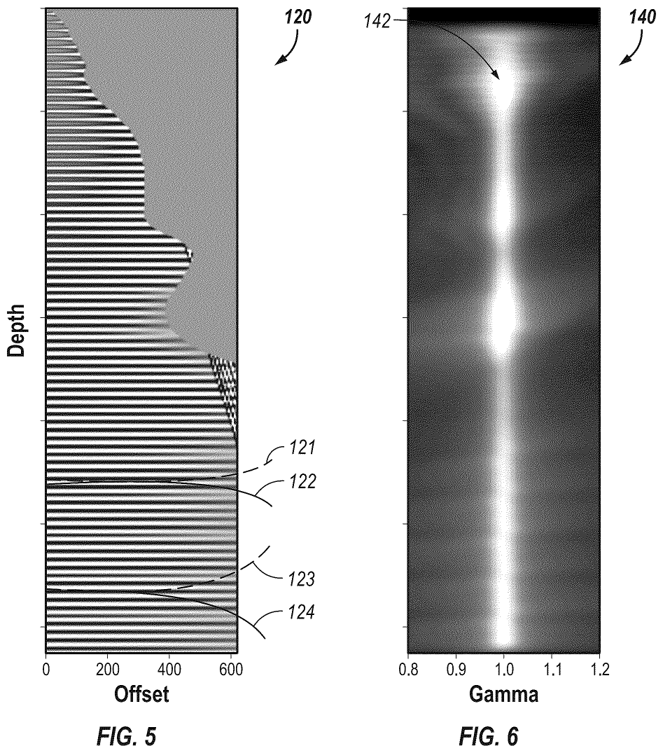

In some embodiments, a migration progress is employed at block 106 to obtain or generate migrated seismic data in the form of one or more prestack migrated seismic gathers. In some embodiments, the one or more prestack migrated seismic gathers generated at block 106 are indexed by surface offset distance. Referring briefly to FIG. 5, an exemplary prestack, depth-migrated (via a velocity model of a subsurface region) seismic gather 120 associated with the subsurface region is shown having a Y-axis that corresponds to vertical depth and an X-axis corresponding to the surface lateral offset in the X-dimension (e.g., extending in a plane containing the seismic source(s) and seismic receiver(s)). As used herein, the term “seismic gather” refers to a collection of seismic traces that share a common geometric attribute. In this exemplary embodiment, seismic gather 120 comprises a common depth point (CDP) gather, and thus, share the common attribute of a common depth point; however, it may be understood that in other embodiments seismic gather 120 may comprise a zero-offset gather, a common image point (CIP) gather, or other types of gathers.

Seismic gather 120 contains a plurality of “ripples” that correspond to subsurface reflectors (e.g., subsurface reflectors 29) of the subsurface region (e.g., subsurface region 26) captured by the received seismic data and depicted visually in seismic gather 120 as alternating “light” and “dark” traces which extend from the left side of gather 120 towards the right side of gather 120 (e.g., extending along the X-axis of gather 120). Whether a subsurface reflector is a “dark” trace or a “light” trace depends on the change in acoustic impedance registered by the trace where dark traces are associated with an increase in acoustic impedance at a given depth associated with the dark trace while light traces are associated with a decrease in acoustic impedance at a given depth associated with the light trace. Rapid flipping between “dark” and “light” traces/reflectors in depth seismic gather 120 indicates the presence of relatively fine subsurface layers at that particular location within the subsurface region while relatively sparse flipping between “dark” and “light” traces/reflectors in gather 120 indicates the presence of relatively thick subsurface layers at that particular location.

The flatness of a given trace of seismic gather 120 indicates the direction (positive or negative) and degree of error in the output of the velocity model (e.g., the estimated seismic velocity) used to produce the seismic gather 120 (e.g., the velocity model constructed at block 104) at the depth associated with the trace. As an example, seismic gather 120 includes traces 121-124, which are curved moving along the X-axis of the input seismic gather 120. Traces 121-124 have been blown up in FIG. 5 and are merely intended to provide an example for the purposes of discussion. Particularly, traces 121, 122 curve upwards such that the depth associated with the trace 121, 122 decreases as the amount of surface offset increases (e.g., moving left-to-right in FIG. 5). Conversely, traces 123, 124 curve downwards such that the depth associated with the trace 121, 122 increases as the amount of surface offset increases (e.g., moving left-to-right in FIG. 5). Thus, the direction of the error is different between traces 121, 122 (positive) and traces 123, 124 (negative). Additionally, the curvature of traces 121, 122 have a first magnitude corresponding to a magnitude of an error of the output of the velocity model at the depth associated with traces 121, 122, while the curvature of traces 123, 124 have a second magnitude (greater than the first magnitude) corresponding to a magnitude of an error of the output of the velocity model at the depth associated with traces 123, 124. The greater magnitude of curvature/error in traces 123, 124 compared to traces 121, 122 illustrates that the output of the velocity model has a greater degree of uncertainty (e.g., uncertainty in the estimated seismic velocity) at the depth associated with traces 123, 124 compared to the uncertainty at the depth associated with traces 121, 122.

Referring again to FIG. 4, at block 108, method 100 comprises generating a semblance panel from the migrated seismic data. In some embodiments, block 108 comprises generating one or more semblance panels from one or more input gathers, such as the input seismic gather 120 shown in FIG. 5. Generally, semblance analysis is used to analyze seismic velocity estimated from a velocity model and focuses on the similarity between and discontinuity between traces of a seismic gather, such as the traces forming the seismic gather 120 shown in FIG. 5. Particularly, as used herein, the term “semblance panel” refers to a panel generated by estimating a semblance energy by calculating the ratio of the energy of a given trace of a seismic gather to the energy of neighboring traces of the seismic gather in an analysis window. By taking the ratio of the energy of a given trace to the energy of neighboring traces, semblance gathers illustrate the uniformity of the traces of a seismic gather at a given depth.

Referring briefly to FIG. 6, an exemplary semblance panel 140 is shown generated from the seismic gather 120 shown in FIG. 5, where the semblance panel 140 has a Y-axis that corresponds to vertical depth and an X-axis corresponding to gamma which is an estimate of the error (normalized to 1) of velocity model. It may be understood that gamma be either positive or negative depending on the direction of the velocity error (e.g., either curving up as with traces 121 and 123 shown in FIG. 6 or curving down as with traces 122 and 124 shown in FIG. 6). As an example, a 0.9 gamma may correspond to a −10% velocity error while a 1.1 gamma may correspond to a +10% velocity error. As shown in FIG. 5, semblance panel 140 is a type of trace heat map having a central energy envelope 142 that extends vertically along FIG. 5 and varies in width as a function of depth. The light shading of the energy envelope 142 indicates a relatively great degree of intensity in the quantity of traces at the given gamma and depth represented in semblance panel 140. In FIG. 5, the width of the energy envelope 142 at a given depth corresponds to the degree error in the seismic gather 120 (from which semblance panel 140 is generated in this example), which corresponds to the degree of uncertainty in the output (e.g., estimated seismic velocity) of the velocity model used to produce seismic gather 120.

Referring again to FIG. 4, at block 110, method 100 comprises defining a semblance energy envelope (extending across a given depth range) for the semblance panel generated at block 108. Particularly, block 110 comprises defining both a lower bound and an upper bound of the semblance energy envelope for the depth range across which the semblance energy envelope extends, where the upper and lower bounds may be used to ultimately help define the uncertainty of an output (e.g., seismic velocity) of the velocity model at a given depth.

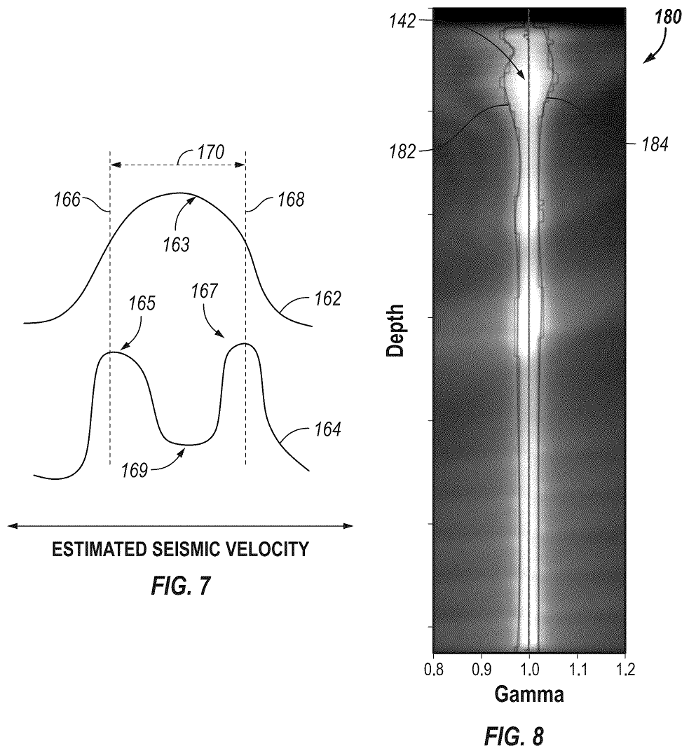

In this exemplary embodiment, the upper and lower bounds of the semblance energy envelope are defined using the seismic velocity estimated from the velocity model used to produce the seismic gather and semblance panel. Particularly, in this exemplary embodiment, the derivative of the migrated seismic data (the semblance energy) y is taken to define the upper and lower bounds of the semblance energy envelope, where the upper and lower bounds correspond to the identified maximum rates of change in semblance energy on each side of the semblance energy envelope. By way of example, and referring briefly to FIG. 7, a first curve 162 is shown indicating estimated seismic velocity at a given depth of a subsurface region produced by one or more velocity models, where the “true” or actual seismic velocity of the subsurface region at the given depth is located along a curved central peak 163 the first curve 162.

FIG. 7 also illustrates a second or derivative curve 164 comprising the derivative of first curve 162, and thus, corresponds to the derivative of the estimated seismic velocity. The derivative curve 164 includes a pair of peaks or maximums—a first or left peak 165 and a second or right peak 167 that flank or straddle the central peak 163 of first curve 162. The left peak 165 comprises a first local maximum adjacent a central trough or minimum 169 of the derivative curve 164, which corresponds to the central peak 163 of the first curve 162. Similarly, the right peak 167 of derivative curve 164 comprises a second local maximum adjacent the central trough 169 of the derivative curve 164. In this example, a first or lower bound 166 is defined by the location of the left peak 165, with the lower bound 166 extending through the left peak 165. Conversely, a second or upper bound 168 is defined by the location of the right peak 167, with the upper bound 168 extending through the right peak 167. Although the first curve 162 of FIG. 7 does not identify the location of the true seismic velocity along first curve 162, it may be assumed that the true seismic velocity falls between the lower bound 166 and upper bound 168, where the distance 170 between bounds 166, 168 corresponds to the uncertainty of the estimated seismic velocity.

Referring now to FIG. 8, a bounded semblance panel 180 is shown produced from the semblance panel 140 of FIG. 6. In this example, the energy envelope 142 of bounded semblance panel 180 is bounded or delimited by a first or lower bound 182 and an opposed second or upper bound 184. In some embodiments, the bounds 182, 184 of envelope 142 are determined, for all depths within the depth range associated with the seismic gather 120, by taking the derivative of the estimated seismic velocity (for a given depth) and selecting the pair of adjacent or local peaks of the derivative curve which straddle the estimated seismic velocity (produced from the velocity model) for the given depth as defining the lower and upper bounds for the estimated seismic velocity at the given depth.

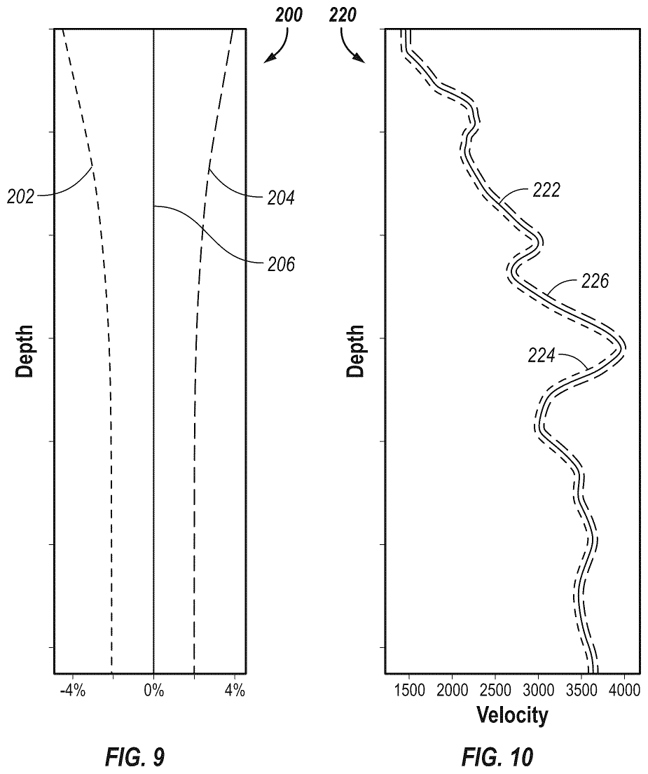

Referring again to FIG. 4, at block 112, method 100 comprises translating the defined semblance energy envelope into pair of seismic velocity scalars. As an example, and referring to FIG. 9, a velocity scalar panel 200 is shown having a Y-axis that corresponds to vertical depth and a unitless, scalar X-axis. Velocity scalar panel 200 includes a first or minimum velocity bound 202 and a second or maximum velocity bound 204 that straddle a baseline 206. The minimum velocity bound 202 of velocity scalar panel 200 comprises a minimum velocity scalar and is derived from the lower bound 182 of bounded semblance panel 180. Similarly, the maximum velocity bound 204 of velocity scalar panel 200 comprises a maximum velocity scalar and is derived from the upper bound 184 of bounded semblance panel 180. For example, the velocity scalars may be determined by subtracting the bounds 182 and 184 from the upper bound 184.

Referring again to FIG. 4, at block 114, method 100 comprises estimating an uncertainty of a seismic velocity of the subsurface region from the pair of velocity scalars produced at block 112. It may be understood that in some embodiments method 100 may not include block 112, and seismic velocity uncertainty may be determined from the defined semblance energy envelope without using the pair of velocity scalars. In some embodiments, block 114 comprises estimating a seismic velocity of the subsurface region over a nonzero depth range, where each estimated seismic velocity (for a given depth) is provided with a lower or minimum velocity bound that is equal to or less than the estimated seismic velocity for the given depth, and an upper or maximum velocity bound that is equal or greater than the estimated seismic velocity for the given depth.

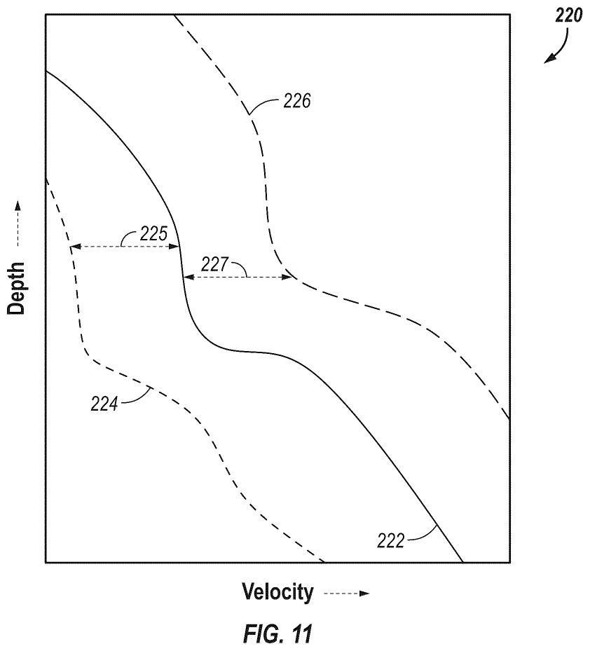

As an example, and referring now to FIG. 10, a graph 220 is shown having a Y-axis that corresponds to vertical depth and an X-axis corresponding to estimated seismic velocity in units of meters per second (m/s). Particularly, graph 220 illustrates estimated seismic velocity 222 as a function of depth. Along with estimated seismic velocity 222, graph 220 includes a lower or minimum velocity bound 224 and an upper or maximum velocity bound 226 each as a function of depth with the estimated seismic velocity 222 falling between the bounds 224, 226 for each given depth.

Referring to FIGS. 10 and 11, FIG. 11 is an enlarged view of a portion of the graph 220 shown in FIG. 10. Particularly, FIG. 11 illustrates the pair of bounds 224, 226 and the estimated seismic velocity 222 for a portion of the depth range shown in FIG. 10. Additionally, FIG. 11 includes a first or lower uncertainty window 225 and a second or upper uncertainty window 227 flanking the estimated seismic velocity 222. Lower uncertainty window 225 may also be referred to herein as low-side uncertainty window 225 while upper uncertainty window 227 may also be referred to herein as high-side uncertainty window 227. In this example, lower uncertainty window 225 extends along the X-axis of graph 220 between the minimum velocity bound 224 and the estimated seismic velocity 222 at a given depth of the subsurface region, while upper uncertainty window 227 extends along the X-axis of graph 220 between the estimated seismic velocity 222 and the maximum velocity bound 226 for the given depth of the subsurface region.

Referring briefly again to FIG. 4, it may be generally understood that in other embodiments of methods for estimating uncertainty of an output of a velocity model of a subsurface region may vary from the exact sequence of steps shown in FIG. 4. For example, in other embodiments, only some of the blocks 102-114 may be performed in estimating uncertainty of the output of the velocity model while in other embodiments additional steps not shown in FIG. 4 may be performed estimating uncertainty of the output of the velocity model. It may be additionally understood that one or more of the blocks 102-114 of FIG. 4 may be repeated. For example, at least some of blocks 106-114 may be performed for each seismic gather obtained from block 106.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for estimating uncertainty of an output of a velocity model of a subsurface region, the method comprising:
(a) receiving seismic data associated with a subsurface region and captured by one or more seismic receivers;
(b) constructing a velocity model of the subsurface region based on the received seismic data;
(c) performing a seismic migration of the received seismic data based on the constructed velocity model to obtain migrated seismic data;
(d) generating a semblance panel from the migrated seismic data; and
(e) estimating an uncertainty of the output of the velocity model based on the generated semblance panel.

2. The method of claim 1, wherein (c) comprises generating one or more seismic gathers using the constructed velocity model.

3. The method of claim 2, wherein the semblance panel is generated from the one or more seismic gathers.

4. The method of claim 1, wherein (e) comprises estimating the uncertainty of a seismic velocity estimated from the velocity model, wherein the uncertainty comprises a lower bound and a separate upper bound.

5. The method of claim 4, wherein a first uncertainty window extends between the lower bound and the estimated seismic velocity and a second uncertainty window extends between the estimated seismic velocity and the upper bound.

6. The method of claim 5, wherein a width of the first uncertainty window and a width of the second uncertainty window vary across different depths of the subsurface region.

7. The method of claim 1, wherein (e) comprises taking a derivative of the output of the velocity model to estimate the uncertainty of the output.

8. A method estimating uncertainty of an estimated seismic velocity produced by a velocity model of a subsurface region, the method comprising:
(a) receiving seismic data associated with a subsurface region and captured by one or more seismic receivers;
(b) constructing a velocity model of the subsurface region based on the received seismic data;
(c) performing a seismic migration of the received seismic data based on the constructed velocity model to obtain migrated seismic data; and
(d) determining, using the velocity model and the migrated seismic data, an estimated seismic velocity of the subsurface region at a given depth, a minimum velocity bound at the given depth that is less than the estimated seismic velocity, and a maximum velocity bound at the given depth that is greater than the estimated seismic velocity.

9. The method of claim 8, wherein the estimated seismic velocity comprises a point along a seismic velocity curve, and wherein (d) comprises taking a derivative of the migrated seismic data to identify the minimum velocity bound and the maximum velocity bound.

10. The method of claim 9, wherein the minimum velocity bound is associated with a first peak along a derivative of the migrated seismic data, and the maximum velocity bound is associated with a second peak along a derivative of the migrated seismic data that is adjacent to the first peak.

11. The method of claim 10, wherein the estimated seismic velocity is associated with a trough along a derivative of the migrated seismic data that is positioned between the first peak and the second peak.

12. The method of claim 8, wherein a first uncertainty window extends between the minimum velocity bound and the estimated seismic velocity, and a second uncertainty window extends between the estimated seismic velocity and the maximum velocity bound.

13. The method of claim 12, wherein a width of the first uncertainty window and a width of the second uncertainty window vary across different depths of the subsurface region.

14. The method of claim 8, wherein (c) comprises generating one or more seismic gathers using the constructed velocity model.

15. The method of claim 14, further comprising:
(e) generating a semblance panel from the migrated seismic data, wherein the semblance panel is generated from the one or more seismic gathers.

16. A system for estimating uncertainty of an output of a velocity model of a subsurface region, the system comprising:
a processor;
a non-transitory memory; and
an application stored in the non-transitory memory that, when executed by the processor:
receives seismic data associated with a subsurface region and captured by one or more seismic receivers;
constructs a velocity model of the subsurface region based on the received seismic data;
performs a seismic migration of the received seismic data based on the constructed velocity model to obtain migrated seismic data;
generates a semblance panel from the migrated seismic data; and
estimates an uncertainty of the output of the velocity model based on the generated semblance panel.

17. The system of claim 16, wherein the output comprises an estimated seismic velocity estimated from the velocity model, and wherein the uncertainty comprises a lower bound and a separate upper bound.

18. The system of claim 17, wherein a first uncertainty window extends between the lower bound and the estimated seismic velocity and a second uncertainty window extends between the estimated seismic velocity and the upper bound.

19. The system of claim 18, wherein a width of the first uncertainty window and a width of the second uncertainty window vary across different depths of the subsurface region.

20. The system of claim 16, wherein the application, when executed by the processor:
takes a derivative of the output of the velocity model to estimate the uncertainty of the output.
